(19) United States
(12) Patent Application Publication
(10) Pub. No.: US 2016/0269720 A1
(43) Pub. Date: Sep. 15, 2016

(54) FLEXIBLE SUBSTRATE DISPLAY PANEL AND PANEL GEOMETRY FOR ERGONOMICS

(71) Applicant: Oculus VR, LLC, Menlo Park, CA (US)

(72) Inventor: Nirav Rajendra Patel, San Francisco, CA (US)

(21) Appl. No.: 15/068,165

(22) Filed: Mar. 11, 2016

Related U.S. Application Data
(60) Provisional application No. 62/131,731, filed on Mar. 11, 2015.

(51) Int. Cl. H04N 13/04

(52) U.S. Cl. CPC H04N 13/044

(57) ABSTRACT

A display apparatus comprises a flexible substrate and a display panel formed on a first surface of the flexible substrate. The display panel comprises a first panel region formed on a first portion of the flexible substrate, the first panel region forming a left eye display unit. The display panel also comprises a second panel region formed on a second portion of the flexible substrate, the second panel region forming a right eye display unit. A second central axis of the second panel region is separated from a first central axis of the first panel region by an inter-axial distance that is adjustable responsive to deformation of a third portion of the flexible substrate that is formed between the first and second portions of the flexible substrate.

### CROSS REFERENCE TO RELATED APPLICATIONS

This application claims the benefit of and priority to Provisional Application Ser. No. 62/131,731, filed Mar. 11, 2015, which is incorporated by reference herein in its entirety.

### BACKGROUND

In a virtual reality headset, left and right eye display areas are formed by separate display units for each eye via separate manufacturing processes on separate substrates and then coupled together or integrated into the virtual reality headset. However, the separate manufacturing processes and subsequent integration of the left and right eye display units do not allow for micron level alignment of corresponding pixels or corresponding pixel rows of the left and right eye units, neither does it allow for uniformity in color and brightness between the two display units.

### SUMMARY

In a virtual reality headset with left and right eye display area with inter-axial adjustment to match the range of inter-pupillary distances (IPDs) on users, rather than having a separate display for each eye, both display areas are formed in a single display module. In this display module, the left and right eye units are fabricated side by side on the same substrate, allowing for micron level alignment as well as greater uniformity in color and brightness. The region between the left and right eye units may be area used for various electronic components (such as wiring, low-temperature polycrystalline silicon (LTPS) thin film transistor (TFT) circuitry, driver circuitry, etc.) as well as unused substrate area. This region buckles and folds to allow for adjustment of the distance between the left and right display areas.

In one or more embodiments, for use in a head mounted display, the active-matrix organic light-emitting diode (AMOLED) substrate can be diced into shapes that accommodate the clearances necessary to make face ergonomics. The nose and brow areas can be cut away symmetrically to avoid creating separate parts for the left and right eyes. Removing this active area also reduces the organic material used in the manufacturing of the AMOLED display panel.

In one or more embodiments, a display apparatus comprises a flexible substrate and a display panel formed on a first surface of the flexible substrate. The display panel comprises a first panel region formed on a first portion of the flexible substrate, the first panel region forming a left eye display unit, a first central axis of the first panel region being perpendicular to scan rows of the first panel region. The display panel further comprises a second panel region formed on a second portion of the flexible substrate, the second panel region forming a right eye display unit, a second central axis of the second panel region being perpendicular to scan rows of the second panel region. The second central axis of the second panel region is separated from the first central axis of the first panel region by an inter-axial distance, and the inter-axial distance between the first and second central axes is adjustable responsive to deformation of a third portion of the flexible substrate that is formed between the first and second portions of the flexible substrate.

### BRIEF DESCRIPTION OF THE DRAWINGS

FIGS. 1A-1B each illustrates a front view of two regions of a single display module separated by a flexible interconnecting substrate, for use within an optical headset or head-mounted display, in accordance with one embodiment.

FIGS. 2A-2B illustrate each top views, of two panel regions of a single display unit separated by a flexible interconnecting substrate, for use within an optical headset or head-mounted display, in accordance with one embodiment.

FIG. 2C illustrates an enlarged top view of the flexible interconnecting substrate region 104 of FIG. 2B in a folded position, according to one embodiment.

FIGS. 3A-3B illustrate non-rectangular display panel geometry for use within an ergonomic optical headset or head-mounted display, according to one embodiment.

FIGS. 4A-4B illustrate display panels with non-rectangular geometries separated by a flexible interconnecting substrate, for use within an ergonomic optical headset or head-mounted display, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

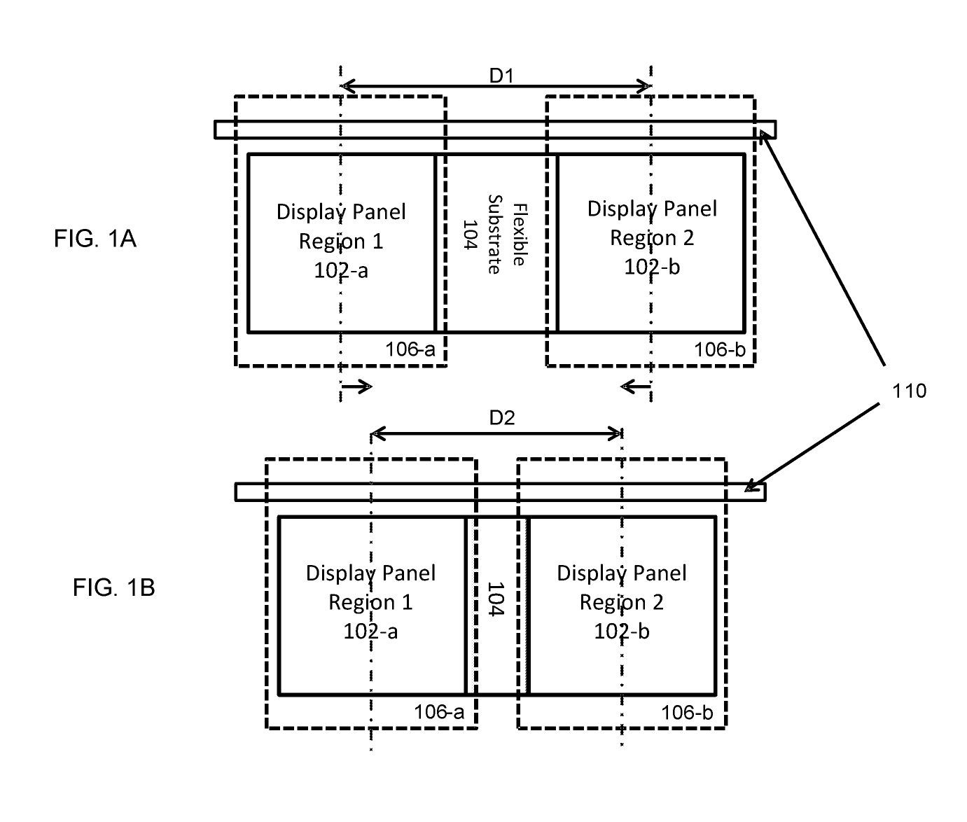

FIGS. 1A-1B each illustrates a front view of two regions of a single display panel separated by a flexible interconnecting substrate, for use within an optical headset, in accordance with one embodiment.

FIG. 1A shows a front view of the two panel regions 102-a and 102-b of a single display unit separated by a first inter-axial separation (D1) suitable for a first inter-pupillary distance. In some embodiments, the two panel regions 102-a and 102-b correspond to a single display unit that are manufactured concurrently during parallel (simultaneous corresponding) manufacturing process steps on the same shared flexible substrate 104 (which also extends in the region between the two panels, share the same display driver circuitry, and may be driven by horizontal row scan lines that traverse both panel regions 102-a, 102-b. In some embodiments, corresponding pixel rows of the first and second panel regions 102-a and 102-b of the display panel are driven by common scan lines. In one embodiment, the single display unit including the two panel regions 102-a, 102-b is an AMOLED display fabricated on a flexible substrate 104 made of flexible material, such as plastic, e.g., polyimide, polyethylene terephthalate (PET), or the like.

This configuration where the two panel regions 102-a and 102-b correspond to a single display unit allows for micron level alignment between the two panels. The scan lines and pixel rows can be better aligned between the two panels since the panels are formed simultaneously via the same processing steps, on the same substrate. In some embodiments, corresponding pixels of the first and second panel regions of the display panel are aligned to match in spatial placements within a certain tolerance referenced to the corresponding panel regions, for example in micrometer ranges. Furthermore, in some embodiments, corresponding pixel rows of the first and second panel regions of the display panel are aligned to match in spatial placements within a certain tolerance referenced to the corresponding panel regions, for example in micrometer ranges. An additional benefit of the two panels being formed concurrently via the same processing steps on a single substrate is that the two panels (individual pixel pairs) or all of the pixels of one panel with respect to another can be better matched for brightness and color responses, thus providing greater uniformity in color and brightness between the two panel regions. Thus, effects of process variations (in spatial alignment and pixel display characteristics) can be mitigated when the two panels are formed on the same substrate via the same process steps. In some embodiments, display characteristics of corresponding pixels of the first and second panel regions of the display panel are matched to have less than a predetermined percentage of difference in luminance response and less than a predetermined percentage of difference in color response.

The two regions 102-a and 102-b may be attached to substantially inflexible mounting regions 106-a and 106-b. The inflexible mounting regions 106-a and 106-b are configured to slide along rails or guides 110. The flexible substrate 104 folds (bends or buckles) to allow for adjustment of the distance between the left and right display regions (102-a and 102-b). In FIG. 1A, the flexible substrate 104 is distended and stretched to substantially its full length, thus allowing for a greater inter-axial separation (D1) between the two regions 102-a and 102-b.

FIG. 1B shows a front view of the two regions of the single display panel of FIG. 1A, the two panel areas 102-a, 102-b separated by a second inter-axial separation (D2) suitable for a second inter-pupillary distance. When the flexible substrate 104 folds (bends or buckles), the distance between the regions 102-a and 102-b decreases (e.g., from D1 to D2). In some embodiments, where guides 110 are provided, the inflexible mounting regions 106-a and 106-b are configured to slide towards or away from each other along the guides 110. Thus, an inter-axial distance (distance between the centers of the display regions) can be reduced from D1 to D2 to accommodate variations in human inter-pupillary distances across users of the device. The range of separations (distances and movement) can be configured to cover 5% to 95% of human IPD variations.

In one or more embodiments, electronic components such as circuit passives, optical components, circuit traces and signal wires that carry electrical or optical signals, active circuit elements (integrated circuits or chips), and/or energy sources such as battery cells may be formed within the flexible substrate region 104 between the two regions of the panel.

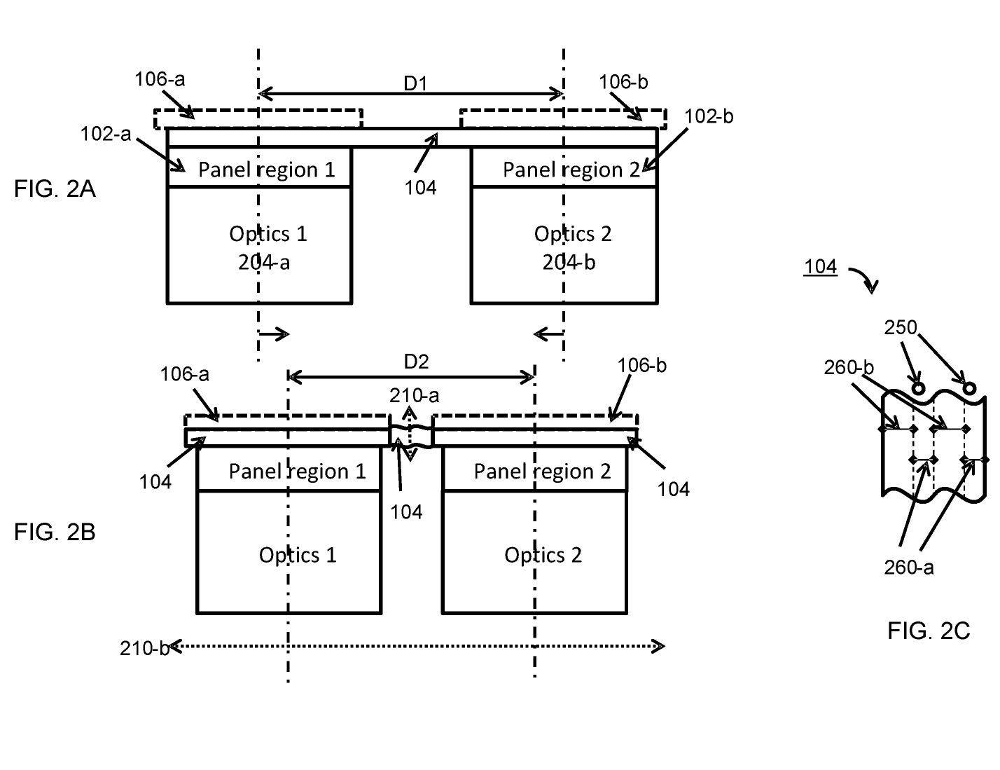

FIGS. 2A-2B each illustrates top views of two regions of the single display panel separated by a flexible interconnecting substrate 104, for use within an optical headset (e.g., head mounted display for a virtual reality system), in accordance with one embodiment. FIGS. 2A-2B are top views corresponding to the front views of FIGS. 1A-1B, according to one embodiment.

In addition to the left and right display panel regions (102-a and 102-b) and the flexible interconnecting substrate region 104, FIGS. 2A-2B also illustrate the optics 204-a and 204-b that are coupled (affixed) to and move with the left and right display panel regions 102-a and 102-b.

FIG. 2A corresponds to the top view of FIG. 1A and illustrates the two display regions 102-a and 102-b of a single display panel that are separated by a first inter-axial separation (D1) suitable for a first human inter-pupillary distance. Similarly, FIG. 2B corresponds to the top view of FIG. 1B and illustrates the two regions 102-a and 102-b of a single display panel that are separated by a second inter-axial separation (D2) suitable for a second human inter-pupillary distance. As shown in FIG. 2A, the flexible substrate 104 is distended and stretched to substantially its full length, thus allowing for a greater inter-axial separation (D1) between the two regions 102-a and 102-b. On the other hand, as illustrated in FIG. 2B, the flexible substrate 104 folds (bends or buckles) to allow for adjustment of the distance between the left and right display regions (102-a and 102-b). The direction 210-a along which the flexible substrate 104 folds is perpendicular to the plane of the two panel regions 102-a and 102-b and also perpendicular to the direction along which the two panels 102-a and 102-b move relative to one another. A radius (minimum, maximum, range) of any individual fold may be defined by the material properties of substrate 104. For example, the flexible substrate may be formed of plastic material that has a minimum fold radius of 3 millimeters.

FIG. 2C illustrates an enlarged top view of the flexible interconnecting substrate region 104 of FIG. 2B in a folded position, according to one embodiment.

The pattern of bending and folding of the flexible substrate region 104 may be controlled or predefined so that the flexible substrate region 104 bends in a fixed and predefined fashion (along predefined fold axes) perpendicular to the interconnecting dimension (length) between the panel regions 102-a and 102-b. This could be achieved via several alternative design configurations. For example, support structures (e.g., ball bearings, cylindrical bearings, or other suitable supporting and pivoting (fold guiding) structures such as structures 250 illustrated in FIG. 2C) located at fixed predefined locations along the interconnecting dimension (length) of flexible substrate region 104 may define axes around which the flexible substrate region 104 bends. Alternatively, or in addition, the flexible substrate region 104 may be formed of bands of materials of different bending moduli or elastic moduli, thus making the flexible substrate region 104 more prone (likely) to bend in certain regions (260-b) where the region 104 is softer, less stiff, and more pliable than other regions (260-a) where the flexible substrate 104 is made of stiffer materials.

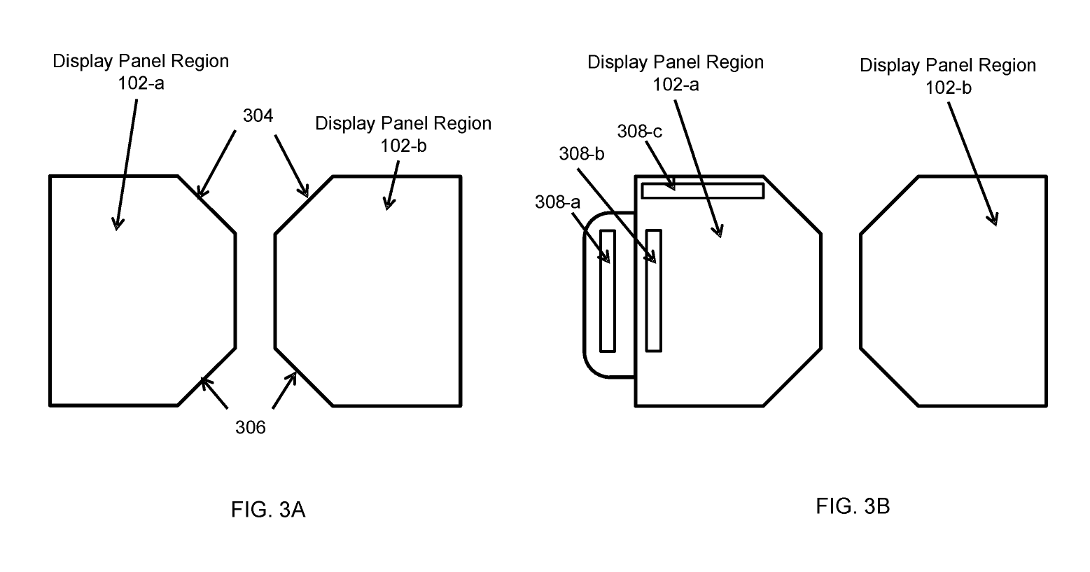

FIGS. 3A-3B illustrate non-rectangular display panel geometry for use within an ergonomic optical headset or head-mounted display, according to one embodiment. In one embodiment, the non-rectangular display panel illustrated in FIGS. 3A-3B are used for the head-mounted display of a virtual reality system.

As shown in FIGS. 3A-3B, portions of the left and right display panels 102-a and 102-b are cut out to accommodate features of the human face (particularly protruding features such as nose, brows, etc.). For example, portion 304 corresponds to an excised region around the brows and portion 306 corresponds to an excised region around the nose. In some embodiments, the excised sections are cut out in the inner region of the right and left panels between the eyes. For example, laser cutting may be used to excise the regions of the flexible substrate of the display to form the portions 304, 306.

In such embodiments, where the first and second panel regions 102-a and 102-b are non-rectangular, widths of upper portions of the first and second panel regions are shorter than respective widths of central portions of the first and second panel regions. In such embodiments, the first and second central axes dissects the respective central portions of the first and second panel regions; and the upper portion of the first panel region 102-a has a greater width to a left of the first central axis and the upper portion of the second panel region 102-b has a greater width to the right of the second central axis. In such embodiments, widths of scan rows in upper portions of the first and second panel regions are shorter than widths of scan rows in the central portions of the first and second panel regions.

Alternatively, or in addition, the first and second panel regions 102-a and 102-b are non-rectangular, widths of lower portions of the first and second panel regions are shorter than respective widths of central portions of the first and second panel regions. In such embodiments, the first and second central axes dissecting the respective central portions of the first and second panel regions; and the lower portion of the first panel region 102-a has a greater width to a left of the first central axis and the lower portion of the second panel region 102-b has a greater width to the right of the second central axis. In such embodiments, widths of scan rows in lower portions of the first and second panel regions are shorter than widths of scan rows in the central portions of the first and second panel regions.

In a stereoscopic display, this region between the eyes corresponds to or a spatial region where the human eyes cannot see—neither the left nor the right eye field of view encompasses this region. Thus, although content that would have been displayed in the excised regions had the rectangular geometry been used, is lost, the loss of the displayed image content does not necessarily result in a loss of perceived image content. This is because the eyes may not have been able to view this region in the first place. In other words, the display regions from the left and right panels are optionally specifically excised in a manner that the excised portions would have fallen within the region between the eyes where the eyes cannot perceive vision. But eliminating these display regions still provides ergonomic benefits.

Although the regions illustrated as being cut out are shown to be linear, other non-linear shapes and contours for delineating the excised regions are possible as well—e.g., curved, curvilinear, piece-wise linear, and so on. The sections that are cut out from the display panel between the two panel regions may be symmetric along the top-down axis and/or along the left-right axis. Alternatively the sections may not be cut out symmetrically along one or both of these axes.

In one or more embodiments, an image that was originally meant for display on a rectangular display is rendered for the non-rectangular display. Portions of image content corresponding to regions that are cut-out may be omitted—e.g., not displayed. In other words the original image meant for rectangular display regions may be truncated at these regions. Image content may be intelligently adjusted or offset within the panel regions so that important display content is preserved. Some display lines (near the top and bottom, where portions are cut out) are shorter than others (near the center where substantially the entire display width is preserved). Thus, fewer display pixels may be provided along the shorter (narrower) display width regions than along the wider display width regions. The scan time for the shorter lines may be reduced in comparison with the scan time for the wider display rows/regions. In the alternative, scan time for the short and long scan lines may be kept substantially the same. In the latter case, the scan time that would have been used for display of image content in the regions that are cut out is idle time (no content is displayed during these scan times).

FIG. 3B additionally illustrates that in one or more embodiments, electronic components such as circuit passives, optical components, circuit traces and signal wires that carry electrical or optical signals, active circuit elements (integrated circuits or chips), and/or energy sources such as battery cells may be formed on a fixture (e.g., made of glass or other suitable material) attached to or adjoining the outer lateral border (as shown in 308-a) of the left and/or right display panel region. Alternatively or in addition such electronic components may be formed on and along a periphery of one or both of the two regions of the panel (around the upper border as shown at 308-c or left or right outer border as shown by 308-b).

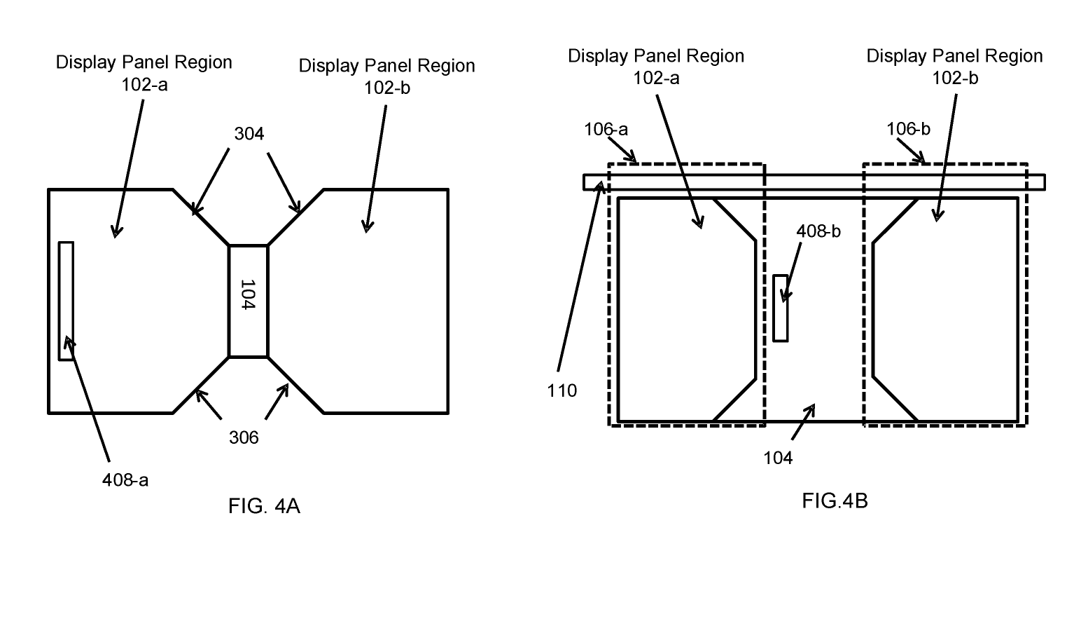

FIGS. 4A-4B illustrate display panels with non-rectangular geometries separated by a flexible interconnecting substrate 104, for use within an ergonomic optical headset (head mounted display), according to one embodiment.

FIG. 4A illustrates left and right display panel regions 102-a and 102-b that are configured to be non-rectangular in shape (as explained above with reference to FIGS. 3A-3B). In addition, the non-rectangular display panels 102-a and 102-b are interconnected by a flexible substrate 104 (as described above with reference to FIGS. 1A-1B and 2A-2B). The flexible substrate 104 folds (bends or buckles) to allow for adjustment of the distance between the left and right display regions (102-a and 102-b), as explained with reference to FIGS. 1A-1B and 2A-2B. When the flexible substrate 104 folds (bends or buckles), the distance between the regions 102-a and 102-b decreases in relation to its maximum distended (out-stretched) length. As explained above with reference to FIG. 3B, portions of the left and right display panels 102-a and 102-b are cut out to accommodate features of the human face (particularly protruding features such as nose, brows, etc.). Again, portion 304 may correspond to an excised region around the brows and portion 306 may correspond to an excised region around the nose. The flexible substrate 104 forms a narrow flexible bridge over the nose area.

As explained above with reference to FIG. 3B, electronic components may be formed on and along a periphery of one or both of the two regions of the panel (upper border, left or right outer border as in 408-a).

FIG. 4B illustrates left and right display panel regions 102-a and 102-b that are configured to be non-rectangular in shape and are interconnected by a flexible substrate 104 (as described above with reference to FIG. 4A). In addition, as explained with reference to FIG. 1A, the two regions 102-a and 102-b are optionally formed within substantially inflexible mounting regions 106-a and 106-b. The mounting regions themselves may or may not be rectangular. The inflexible mounting regions 106-a and 106-b are optionally configured to slide along rails or guides 110 to increase or decrease the separation between the left and right display panel regions 102-a and 102-b in accordance with the flexing or folding of the flexible substrate 104. In one or more embodiments, electronic components such as circuit passives, optical components, circuit traces and signal wires that carry electrical or optical signals, active circuit elements (integrated circuits or chips), and/or energy sources such as battery cells may be formed within the flexible substrate region 104 between the two regions 102-a and 102-b of the panel as in 408-b.

What is claimed is:

1. A display apparatus comprising:
a flexible substrate; and
a display panel formed on a first surface of the flexible substrate, the display panel comprising:
a first panel region formed on a first portion of the flexible substrate, the first panel region forming a left eye display unit, a first central axis of the first panel region being perpendicular to scan rows of the first panel region, and
a second panel region formed on a second portion of the flexible substrate, the second panel region forming a right eye display unit, a second central axis of the second panel region being perpendicular to scan rows of the second panel region,
wherein:
the second central axis of the second panel region is separated from the first central axis of the first panel region by an inter-axial distance,
the inter-axial distance between the first and second central axes is adjustable responsive to deformation of a third portion of the flexible substrate that is formed between the first and second portions of the flexible substrate.

2. The display apparatus of claim 1, wherein display characteristics of corresponding pixels of the first and second panel regions of the display panel are matched to have less than a first predetermined percentage of difference in luminance response and less than a second predetermined percentage of difference in color response.

3. The display apparatus of claim 1, wherein corresponding pixels of the first and second panel regions of the display panel are aligned to match in spatial placements within a predetermined tolerance referenced to the corresponding panel regions.

4. The display apparatus of claim 1, wherein corresponding pixel rows of the first and second panel regions of the display panel are aligned to match in spatial placements within a predetermined tolerance referenced to the corresponding panel regions.

5. The display apparatus of claim 1, wherein corresponding pixel rows of the first and second panel regions of the display panel are driven by common scan lines.

6. The display apparatus of claim 1, wherein the deformation of the third portion of the flexible substrate corresponds to one or more folds formed within the third portion of the flexible substrate, the folds formed parallel to the first and second central axes of the first and second panel regions.

7. The display apparatus of claim 6, wherein the one or more folds formed in the third portion of the flexible substrate are configured to form along predefined fold axes oriented parallel to the first and second central axes, the predefined fold axes defined by predefined placements of fold guiding structures.

8. The display apparatus of claim 6, wherein the one or more folds formed in the third portion of the flexible substrate are configured to form along predefined fold axes oriented parallel to the first and second central axes, the predefined fold axes defined by bands of alternating flexible materials of distinct elastic moduli.

9. The display apparatus of claim 1, further comprising first and second rigid mounts formed on a second surface of the flexible substrate, the first and second rigid mounts respectively overlapping the first and second panel regions.

10. The display apparatus of claim 9, further comprising a guide member formed perpendicular to the first and second central axes of the first and second panel regions, wherein the first and second rigid mounts are coupled to the guide member and configured to slide along the guide member responsive to an adjustment in the inter-axial distance between the first and second central axes.

11. The display apparatus of claim 1, further comprising one or more electronic components formed on the third portion of the substrate.

12. The display apparatus of claim 1, wherein the electronic components formed on the third portion of the substrate comprise integrated circuit chips or power sources.

13. The display apparatus of claim 1, wherein:
the first and second panel regions are non-rectangular, widths of upper portions of the first and second panel regions being shorter than respective widths of central portions of the first and second panel regions, the first and second central axes dissecting the respective central portions of the first and second panel regions; and
the upper portion of the first panel region having a greater width to a left of the first central axis and the upper portion of the second panel region having a greater width to the right of the second central axis.

14. The display apparatus of claim 13, wherein widths of scan rows in upper portions of the first and second panel regions are shorter than widths of scan rows in the central portions of the first and second panel regions.

15. The display apparatus of claim 1, wherein:
the first and second panel regions are non-rectangular, widths of lower portions of the first and second panel regions being shorter than respective widths of central portions of the first and second panel regions, the first and second central axes dissecting the respective central portions of the first and second panel regions; and
the lower portion of the first panel region having a greater width to a left of the first central axis and the lower portion of the second panel region having a greater width to the right of the second central axis.

16. The display apparatus of claim 15, wherein widths of scan rows in lower portions of the first and second panel regions are shorter than widths of scan rows in the central portions of the first and second panel regions.
